(19) United States
(12) Patent Application Publication
(10) Pub. No.: US 2003/0027457 A1
(43) Pub. Date: Feb. 6, 2003

(54) Foolproof flash ROM package/socket design

(76) Inventors: Shih Tung-Ho, Taipei Hsien (TW); Lin Tsung-Yi, Taipei (TW)

Correspondence Address: J.C. Patents, Inc., 4 Venture, Suite 250, Irvine, CA, 92618, US

(21) Appl. No.: 10/033,750

(22) Filed: Dec. 19, 2001

(30) Foreign Application Priority Data
Aug. 2, 2001 (TW) 90118847

(51) Int. Cl. H01R 13/64

(52) U.S. Cl. 439/680

(57) ABSTRACT

A foolproof mechanism for joining a flash read-only-memory package and a socket base is disclosed. The mechanism has a first foolproof element on the package body and a second foolproof element on the socket base capable of engaging with the first foolproof element. This invention also provides a foolproof mechanism for joining an integrated circuit package and a corresponding socket base. The mechanism has a first foolproof element on the integrated circuit package body and a second foolproof element on the integrated circuit socket base capable of engaging with the first foolproof element.

### CROSS-REFERENCE TO RELATED APPLICATION

This application claims the priority benefit of Taiwan application serial no. 90118847, filed Aug. 2, 2001.

### BACKGROUND OF THE INVENTION

1. Field of Invention

The present invention relates to a design for engaging a flash read-only memory (ROM) package with a socket base. More particularly, the present invention relates to a foolproof design for plugging a flash ROM package into a socket base.

2. Description of Related Art

Before plugging a flash read-only-memory (ROM) package into a socket base, the package needs to be properly orientated. A cut mark on the packages and corresponding cut marks on the socket bases are often used as direction indicators. In fact, a similar approach is also used to orient other integrated circuit packages when plugging into associated socket bases.

Conventional approach for plugging flash ROM packages only relies on cut marks in accompanied with people' visual observations, which is obvious an unsafe way especially the judgements based on visual observations still remain uncertainties. However, the packages may be wrongly plugged into the socket bases with incorrect pin-connections or orientation that are caused from people' misjudgments or very small cut marks on the packages and sockets. Those fault actions may lead to package malfunction or burning-out. If no proper solution for dealing with the above disadvantages is given, the package may catch fire and result in an industrial disaster. To avoid unwanted accidents, a foolproof design permitting the engagement of a flash ROM package with a socket base only in a definite orientation is always desirable.

FIG. 1A is a top view of a conventionally standardized flash ROM package for use in industry. FIG. 1B is a front view of the standardized flash ROM package in FIG. 1A. FIG. 1C is a side view corresponding to the standardized flash ROM package in FIG. 1A. The flash read-only memory (ROM) 100 has a total of 32 leads 140 and a cut mark 120. The cut-mark 120 serves as a visual reminder to user regarding plugging orientation.

FIG. 2A is a top view of a conventional socket base for holding a standardized industrial flash ROM package. FIG. 2B is a front view of the socket base in FIG. 2A. FIG. 2C is a side view corresponding to the socket base in FIG. 2A. The socket base 200 for holding a flash read-only memory (ROM) package has a total of 32 lead holes 240 for accommodating the leads 140 corresponding to the standardized flash ROM package 100 in FIG. 1 and a cut mark 220. The cut-mark 220 serves as a visual reminder to a user regarding plugging orientation.

Before plugging the flash ROM package 100 into the socket base 200, a user needs to orient the cut-mark 120 on the package 100 and the cut-mark 220 on the socket base 200 together on the same side and position the leads 140 directly over corresponding lead holes 240.

In brief, a user must rely on his visual acuity with regard to the cut-mark to plug the package 100 onto the socket 200. However, the flash ROM 100 may be destroyed when the user is negligent in plugging the flash ROM by incorrect pin-connections and orientation. The package may catch fire and further result in unexpected industrial disaster.

### SUMMARY OF THE INVENTION

Accordingly, one object of the present invention is to provide a foolproof design for plugging a flash read-only-memory (ROM) package into a socket base so that reverse plugging or out-of-step plugging is prevented.

A second object of this invention is to provide a foolproof design for minimizing the occurrence of package burning-out due to reverse or incorrect engagement of a flash read-only-memory (ROM) package and a socket base.

To achieve these and other advantages and in accordance with the purpose of the invention, as embodied and broadly described herein, the invention provides a foolproof design for connecting a flash ROM package with a flash ROM socket base. The design includes a first foolproof element on a flash ROM package and a second foolproof element on the socket base at a location corresponding to the first foolproof element. The first foolproof elements are capable of pointing out an engaging direction, while the second foolproof elements are also capable of giving indications for accepting the first foolproof elements.

In a first embodiment of this invention, the first foolproof element on the flash ROM package is a single or multiple protruding sections from the body of the package. These protruding sections are non-symmetrical with respect to the package body. The second foolproof element on the socket base is a single or multiple recess cavities that each one has a profile corresponding to the protruding section. The recess cavities on the socket base accept corresponding protruding sections on the package body for mount the flash ROM package in the socket base.

In addition, the foolproof mechanism for engaging a flash ROM package with a socket base can be applied to engage an integrated circuit package with an integrated circuit socket base. The design includes a first foolproof element on the integrated circuit package and a second foolproof element on the socket base at a location corresponding to the first foolproof element. The first foolproof elements are capable of pointing out a direction and the second foolproof elements are capable of accepting the first foolproof elements.

In a second embodiment of this invention, the first foolproof element on the integrated circuit package is a single or multiple protruding sections from the body of the package. These protruding sections are non-symmetrical with respect to the package body. The second foolproof element on the integrated circuit socket base is a single or multiple recess cavities that each one has a profile corresponding to the protruding section. The recess cavities on the socket base accept corresponding protruding sections on the package body while engaging.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a top view of a conventionally standardized industrial flash ROM package;

FIG. 1B is a front view of the standardized flash ROM package in FIG. 1A;

FIG. 1C is a side view corresponding to the standardized flash ROM package in FIG. 1A;

FIG. 2A is a top view of a conventional socket base for holding a standardized industrial flash ROM package;

FIG. 2B is a front view of the socket base in FIG. 2A;

FIG. 2C is a side view corresponding to the socket base in FIG. 2A;

FIG. 3A is a top view of a flash ROM package having a foolproof element according to this invention;

FIG. 3B is a front view of the flash ROM package in FIG. 3A;

FIG. 3C is a side view corresponding to the flash ROM package in FIG. 3A;

FIG. 4A is a top view of a socket base having a foolproof element for holding a flash ROM package according to this invention;

FIG. 4B is a front view of the socket base in FIG. 4A; and

FIG. 4C is a side view corresponding to the socket base in FIG. 4A.

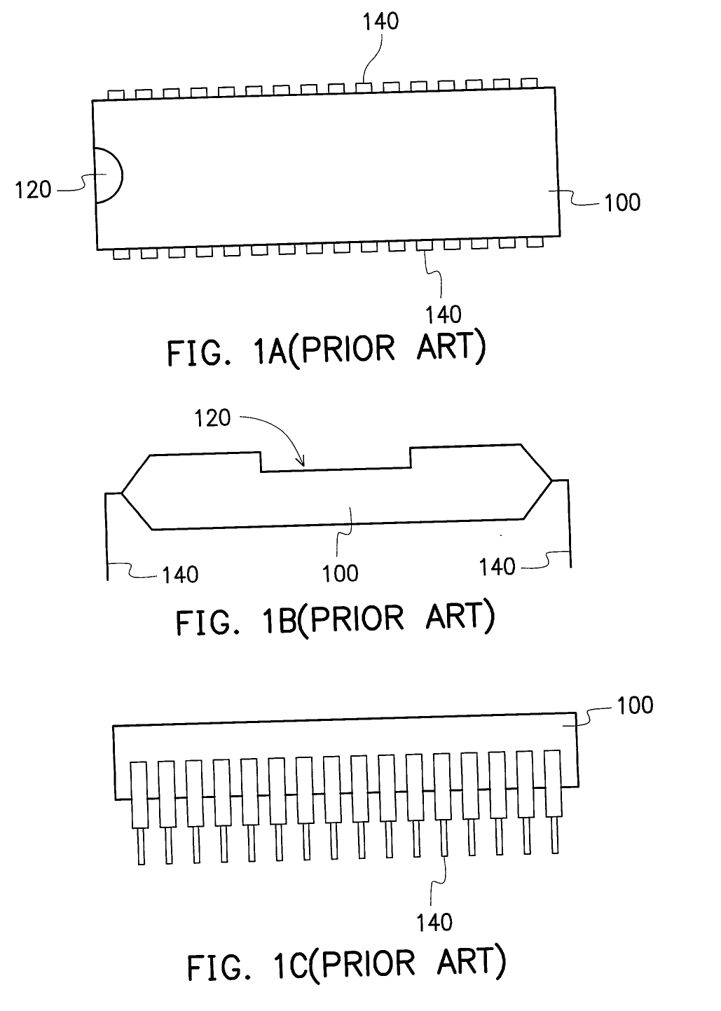

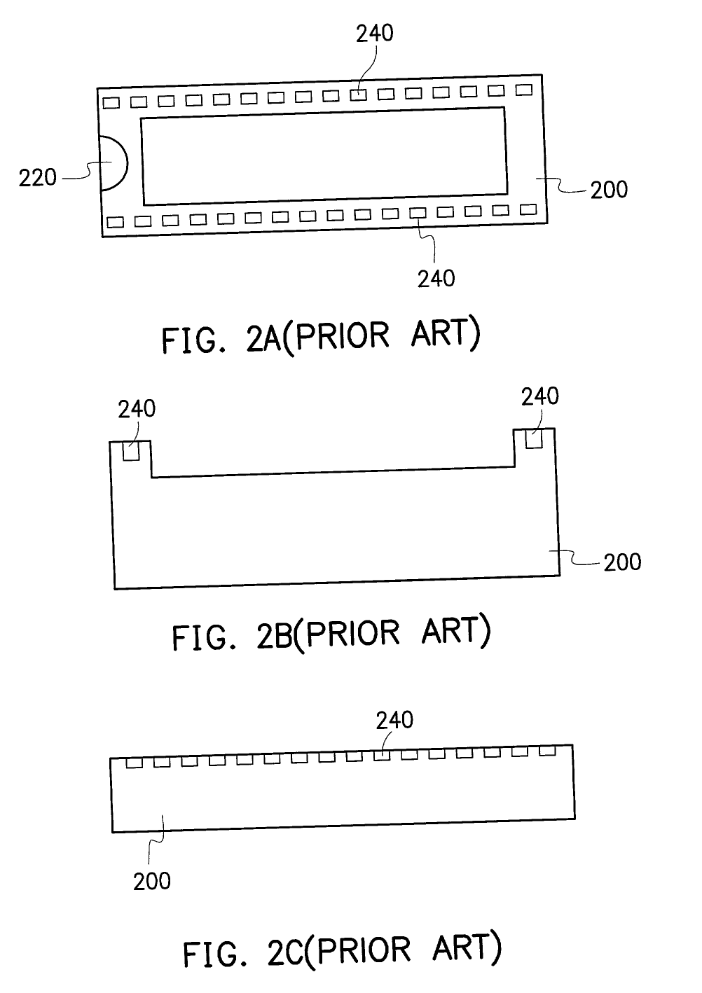

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

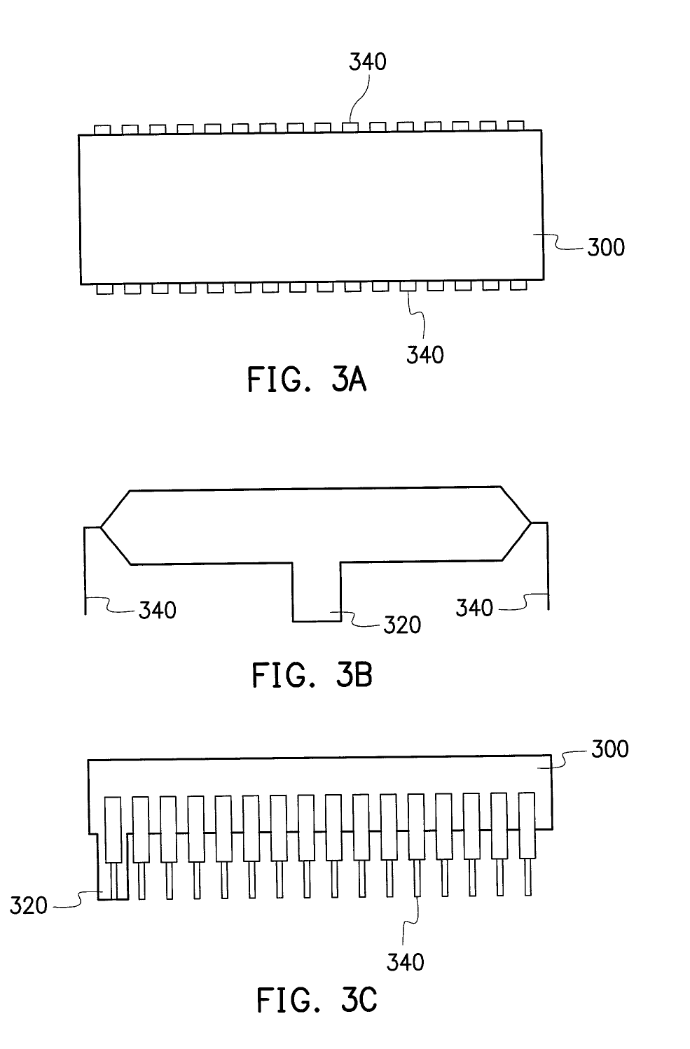

FIG. 3A is a top view of a flash ROM package having a foolproof element according to this invention. FIG. 3B is a front view of the flash ROM package in FIG. 3A. FIG. 3C is a side view corresponding to the flash ROM package in FIG. 3A. The flash read-only-memory (ROM) package body 300 consists of 32 leads 340 and a first foolproof element 320. The first foolproof element 320 is a protruding section. Obviously, the first foolproof element 320 may comprise just one protruding section or multiple protruding sections that are non-symmetrical with respect to the package body (e.g., allocating only at the left side of the package body 300). The protruding section or sections can be used to form a foolproof element or elements as long as the protruding section or sections are capable of pointing out a direction on the package body.

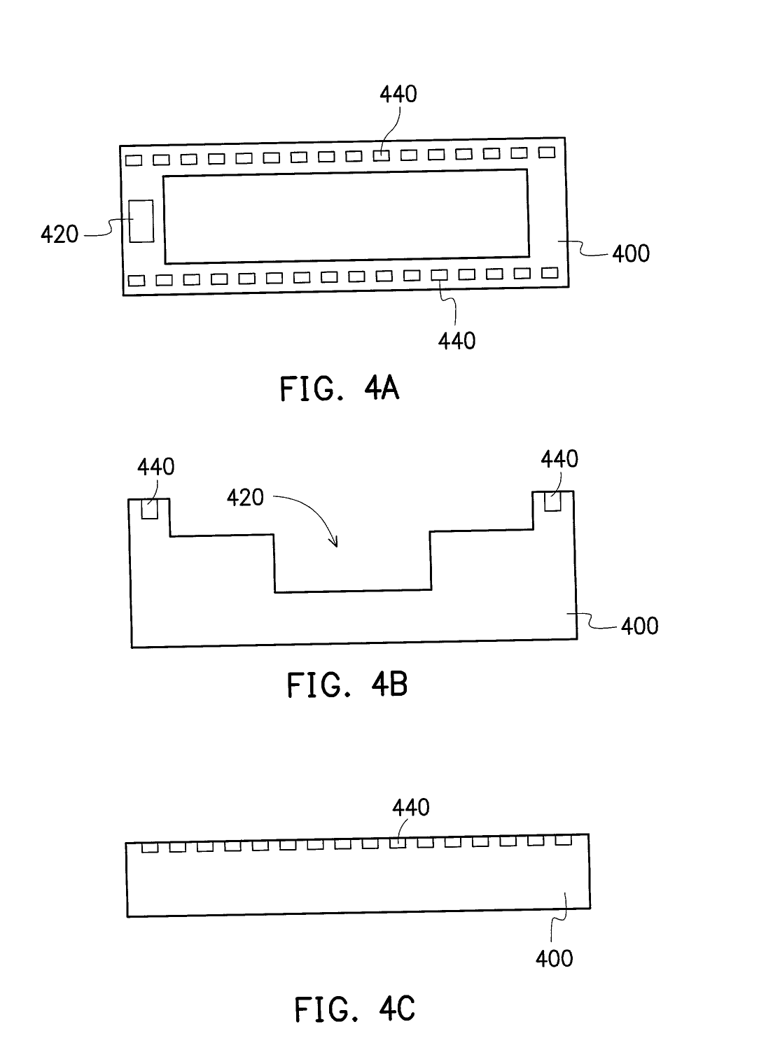

FIG. 4A is a top view of a socket base having a foolproof element for holding a flash ROM package according to this invention. FIG. 4B is a front view of the socket base in FIG. 4A. FIG. 4C is a side view corresponding to the socket base in FIG. 4A. The socket base 400 has 32 lead holes 440 that correspond with the leads 340 on the package body 300 and a second foolproof element 420. The second foolproof element 420 is a recess cavity. Obviously, the second foolproof element 420 may comprise just one recess cavity or multiple recess cavities according to the numbers of the protruding sections 320. The recess cavities 420 on the socket base 400 match the protruding sections 320 on the flash ROM package body 300 in location. Thus, the recess cavities 420 are also non-symmetrical with respect to the socket base 400 that the package body 300 and the socket base 400 can engage with each other.

The flash ROM package 300 can plug into the flash ROM socket base 400 through a unique matching between the first foolproof elements 320 and the second foolproof elements 420. Hence, the foolproof design of this invention is able to prevent the flash ROM package 300 from reverse plugging or putting the wrong pins into the pin holes of the socket base 400. In addition, this foolproof design can equally be used in other integrated circuit packages that need to engage with an integrated circuit socket base.

In this embodiment, shape of the protruding elements on the flash ROM package and the recess cavities on the socket base are drawn for illustrative purposes only and hence should by no means be regarded as a detail disclosure as such. Note that the foolproof mechanism in this invention can also be applied to various integrated circuit packages and their integrated circuit socket bases. A motherboard may employ the disclosed foolproof designs to mounted socket bases so that those computer systems or the likes that mount the motherboard should have protections against improper plugging orientations. Additionally, although the first and second foolproof elements are respectively protruding sections and recess cavities, a skilled person in the art may modify the embodiment to make his first and second foolproof elements being recess cavities and protruding sections, respectively. However, any modification or rearrangement within the spirits of the present invention should be included in the appended claims as follows.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A foolproof mechanism for joining a flash read-only-memory (ROM) package and a socket base, comprising:
a first foolproof element on the flash ROM package, wherein the first foolproof element is non-symmetrical relative to a package body of the flash ROM package and is a direction indictor for mounting the flash ROM package; and
a second foolproof element on the flash ROM socket base, wherein the second foolproof element and the first foolproof element are in matching locations on the package and the socket, respectively, so that the second foolproof element and the first foolproof element can engage with each other.

2. The foolproof mechanism of claim 1, wherein the first foolproof element comprises at least one protruding section mounted on the package body.

3. The foolproof mechanism of claim 1, wherein the second foolproof element comprises at least one recess cavity that each the recess cavity is corresponding in position to and engaging with a protruding section on the package body.

4. The foolproof mechanism of claim 1, wherein the socket base is mounted on a motherboard.

5. The foolproof mechanism of claim 1, wherein the first foolproof element comprises at least one recess cavity that is non-symmetrical relative to the package body and the second foolproof element comprises at least one protruding section, wherein each the protruding section is corresponding in position to one of the recess cavities for engaging.

6. A foolproof mechanism for joining an integrated circuit package and an integrated circuit socket base, comprising:
a first foolproof element on the integrated circuit package, wherein the first foolproof element is non-symmetrical relative to a package body of the integrated circuit package and is a direction indictor for the integrated circuit package; and
a second foolproof element on the integrated circuit socket base, wherein the second foolproof element and the first foolproof element are in matching locations on the package and the socket, respectively, so that the second foolproof element and the first foolproof element can engage with each other.

7. The foolproof mechanism of claim 6, wherein the first foolproof element comprises one or more protruding sections.

8. The foolproof mechanism of claim 6, wherein the second foolproof element comprises one or more recess cavities corresponding in position to and engaging with the protruding section or sections on the package body.

9. The foolproof mechanism of claim 6, wherein the socket base is mounted on a motherboard.

10. The foolproof mechanism of claim 6, wherein the first foolproof element comprises at least one recess cavity that is non-symmetrical relative to the package body and the second foolproof element comprises at least one protruding section, wherein each the protruding section is corresponding in position to one of the recess cavities for engaging.
